(19) United States
(12) Patent Application Publication
(10) Pub. No.: US 2008/0155831 A1
(43) Pub. Date: Jul. 3, 2008

(54) Razors

(76) Inventor: Terence Gordon Royle, Hampshire (GB)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/665,236

(22) PCT Filed: Oct. 11, 2005
(86) PCT No.: PCT/GB05/03909

§ 371 Date: Jan. 15, 2008

(30) Foreign Application Priority Data
Oct. 18, 2004 (GB) 0423151.0

(51) Int. Cl. B26B 19/00; B26B 19/42; B26B 19/44; B26B 19/14; B26B 19/28; B26B 21/52

(52) U.S. Cl. 30/34.1; 30/34.2; 30/41; 30/43.4; 30/45; 30/527

(57) ABSTRACT

A safety razor has a handle (1) and a head structure (5) mounted for pivotable movement relative to the handle during shaving. The head structure (5) includes a motor (18) housed in a sealed chamber (9) for driving a device in use of the razor, such as to reciprocate a guard component or a blade, to vibrate the head structure, to actuate a dispensing device for delivering a shaving enhancement fluid, or to oscillate a support platform (101) on which a blade unit (110) is mounted. The shaving cartridge can include a guard component (38) with projections (39) which are moved towards and away from the skin being shaved when the guard component is reciprocated by the motor (18).

### FIELD OF THE INVENTION

This invention is concerned with razors and in particular relates to safety razors including electric motors.

### BACKGROUND OF THE INVENTION

Safety razors generally comprise a handle by means of which one or more blades with sharp cutting edges are moved across the surface of the skin in performing a shaving stroke with the razor. There have been many proposals to include an electric motor in a safety razor, for example, for driving a vibration mechanism, e.g. an eccentric weight, for vibrating the razor when it is in use, as described for example in U.S. Pat. No. 5,299,354 (Metcalf), or for moving a component of a blade unit mounted on the razor handle as described in EP-A-0906814 (Orloff), WO-A-96/25276 (Avidor) (FIGS. 12-15) and WO-A-2004/018165 (Zuidervaart). In the prior art constructions the electric motor is housed within the razor handle and a transmission arrangement is generally needed to couple the output shaft of the motor to the device being driven. When the motor driven device is located at a head of the razor and remote from the handle, the transmission can be complicated, especially if a component of blade unit is to be reciprocally driven. In recent years it has become common for safety razors to be provided with blade units that are mounted for pivotal movement relative to the razor handle for following the skin contours as the blade unit is moved across the skin surface. To transmit motion from a motor housed in the razor handle to a component of a pivotable blade unit adds complication to the transmission system and the inclusion of gear components or the like within a blade unit intended to be discarded when the cutting edges have lost the sharpness needed for efficient shaving is not an economically viable solution.

There are known from U.S. Pat. No. 3,797,109 (Yamada) and EP-A-1375089 (Shiba) electric dry razors, as opposed to safety razors, in which an assembly including a foil, an undercutter that cooperates with the foil and a motor for driving the undercutter, is mounted for pivotal adjustment on a body structure for holding the body.

### SUMMARY OF THE INVENTION

In accordance with the present invention there is provided a safety razor comprising

a handle;

a head structure pivotally connected to the handle, the head structure being pivotable relative to the handle in use of the razor;

a motor-driven device; and

a motor for actuating the motor driven device, the motor being located within the head structure.

By accommodating the motor within the pivotal head structure the transmission between the motor and a motor driven device disposed at the razor head can be kept simple and as a result can be economic to manufacture.

In a preferred embodiment, the handle has opposed upper and lower ends and the head structure is pivotally connected to the upper end for pivoting about an axis transverse to the length of the handle. The motor is housed in a sealed chamber formed within a body of the head structure, an output drive member of the motor extending in a sealed manner through an end wall of the chamber for cooperation with a driven element disposed outside the chamber. The seal conveniently takes the form of a flexible member inserted between the driven element and the chamber wall. The motor is conveniently a rotary motor, but a linear motor is also possible, and advantageously the motor has an axis parallel with the pivotal axis of the head structure. The head structure includes a mounting structure for detachably mounting a replaceable blade unit on the head structure. Replaceable blade units are commonly referred to as shaving cartridges and include all the razor components that usually contact the skin during shaving. Because the head structure is pivotable relative to the handle a simple mounting structure is possible so that the cartridge is fixedly positioned relative to the head structure, but nonetheless is still able to pivot relative to the handle for following the skin contours in the performance of a shaving stroke.

The razor handle conveniently includes a battery compartment to house a replaceable or rechargeable battery. Electric conductors can be routed between the battery and the motor via or independently of the pivoted connection between the head structure and the handle, such as through a flexible tube connected between them.

In one particular embodiment, the motor has a rotatably driven output member that is coupled to a mechanism that converts the rotary motion into a reciprocal motion, for example for actuating a movable skin contacting component of the razor. The skin contacting component may comprise a blade. Alternatively the skin contacting component may have elements for contact with the skin at discrete locations and be arranged to be reciprocated in a direction towards and away from the skin. The skin contacting component may be a guard element for contact with the skin in front of the cutting edge of a blade in the performance of a shaving stroke, or a cap element that contacts the skin behind a blade. According to another arrangement the motor driven device actuates a skin contacting member that is operable to lift and/or extend hairs before they are cut. Another possibility is for the motor-driven device to be operable to adjust or vary the relative positions of skin contacting components for changing the shaving geometry of the shaving cartridge.

In another embodiment the motor driven device is a vibration mechanism for vibrating the head structure. Alternatively or additionally the safety razor may include a dispensing device, e.g. a pump, to deliver a shaving enhancement fluid such as lubricant and/or moisturising liquid for application to the skin, or a hair trimming device, the dispensing device and/or hair trimming device being actuable by means of the motor.

### DESCRIPTION OF THE DRAWINGS

A more complete understanding of the invention and its preferred features and advantages will be gained from the detailed description that follows, reference being made to the accompanying drawings in which:

FIG. 1 is a top plan of an upper part of a safety razor embodying the invention;

FIG. 2 is a front elevation of the safety razor of FIG. 1;

FIG. 3 is a rear elevation of the safety razor shown in FIG. 1;

FIG. 4 is a partly cut away side elevation of the safety razor shown in FIG. 1;

FIG. 5 is a cross-section taken along the line V-V in FIG. 4;

FIG. 6 is an isometric view of the safety razor of FIG. 1;

FIG. 7 is a cross-section taken along the line VII-VII in FIG. 5;

FIG. 8 is an isometric view of a second embodiment of the invention;

FIG. 9 shows the second embodiment in a vertical cross section;

FIG. 10 is a top plan of the second embodiment;

FIG. 11 is a rear elevation of the second embodiment;

FIG. 12 is an isometric view of the second embodiment with some parts removed for illustration purposes;

FIG. 13 is a bottom plan view of the second embodiment with a motor housing part removed to show the interior of the motor chamber;

FIG. 14 is an isometric view showing a third embodiment of a safety razor according to the invention

FIG. 15 is a view corresponding to FIG. 14 but showing the razor with some parts omitted;

FIG. 16 is a top plan view of the razor of FIG. 14;

FIG. 17 is a top plan view illustrating the razor as it is shown in FIG. 15;

FIG. 18 is an isometric view of a safety razor according to a fourth embodiment of the invention;

FIG. 19 is a cross-section through the safety razor of FIG. 18;

FIG. 20 is a top plan of the razor shown in FIG. 18;

FIG. 21 is a top plan view of the razor of FIG. 18, but with the cartridge and motor housing cover removed;

FIG. 22 is a front elevation of the safety razor of FIG. 18

FIG. 23 shows a fifth embodiment of the invention in an isometric view;

FIG. 24 is an exploded view of the head structure of the safety razor shown in FIG. 23;

FIG. 25 is a cross-section through the safety razor of FIG. 23; and

FIG. 26 is an enlarged cross-section through the head structure of the razor shown in FIG. 23.

### DETAILED DESCRIPTION OF THE PREFERRED EMBODIMENTS

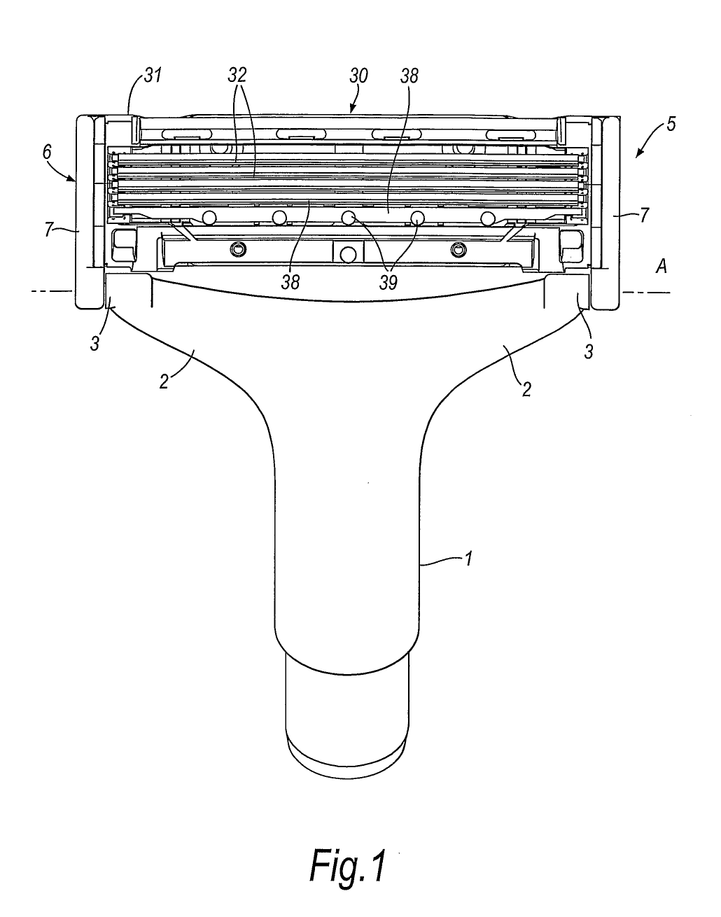

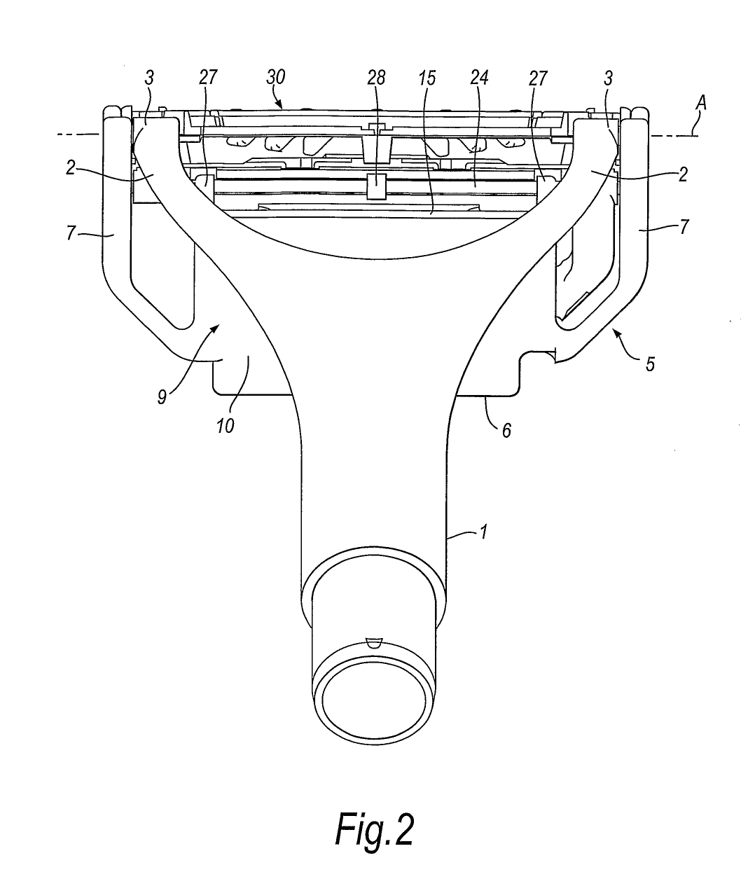

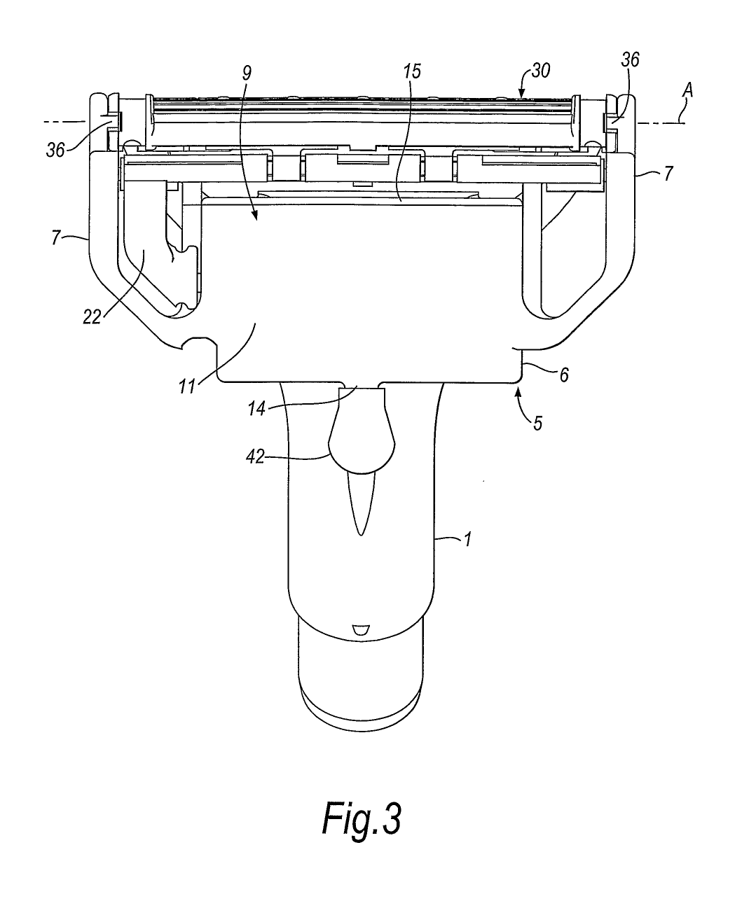

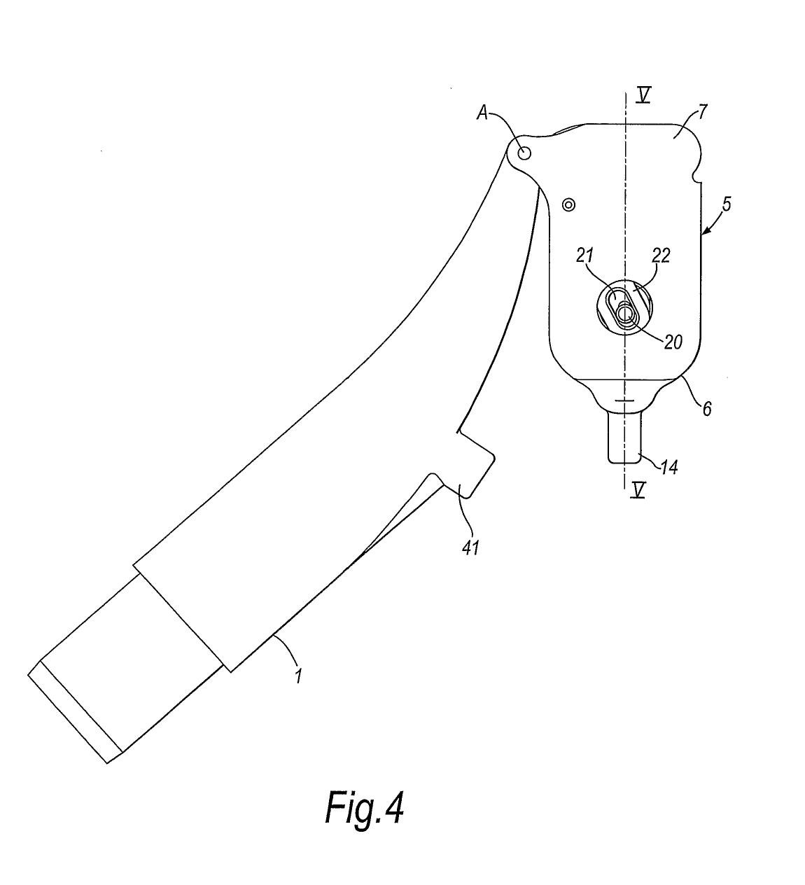

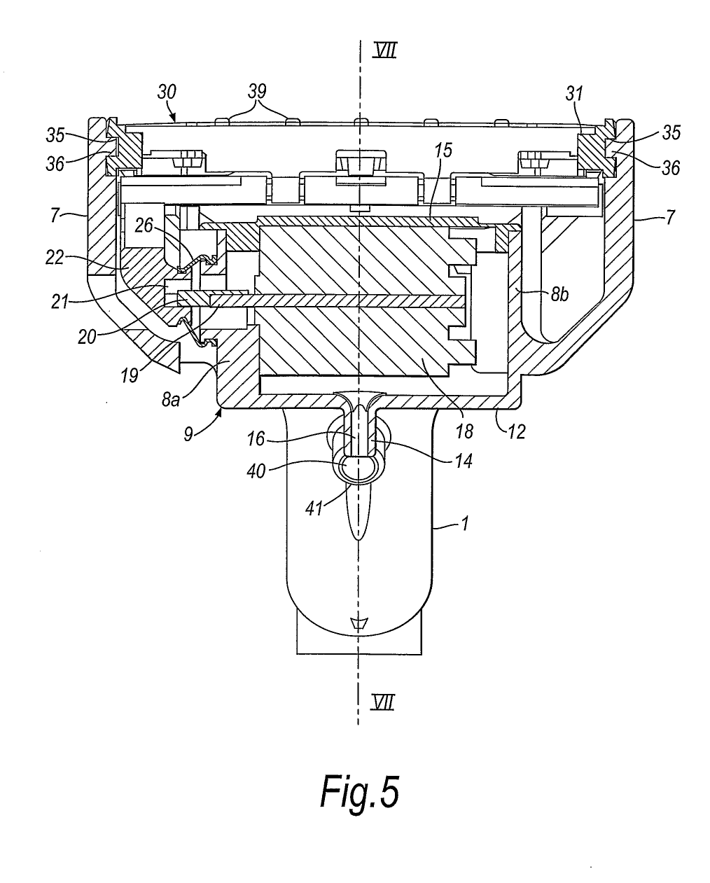

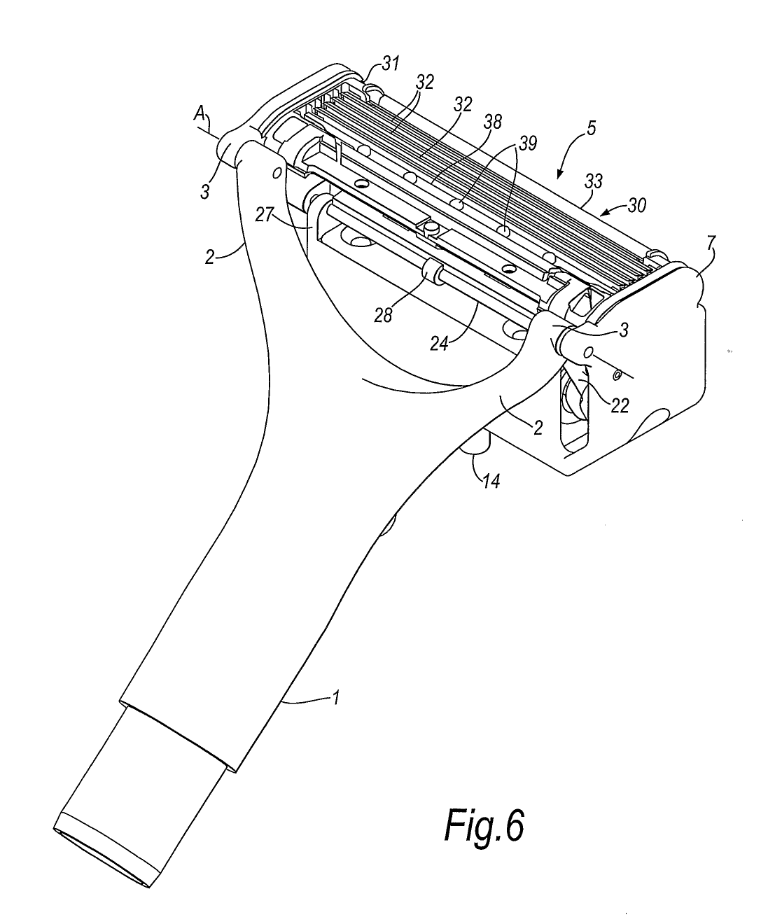

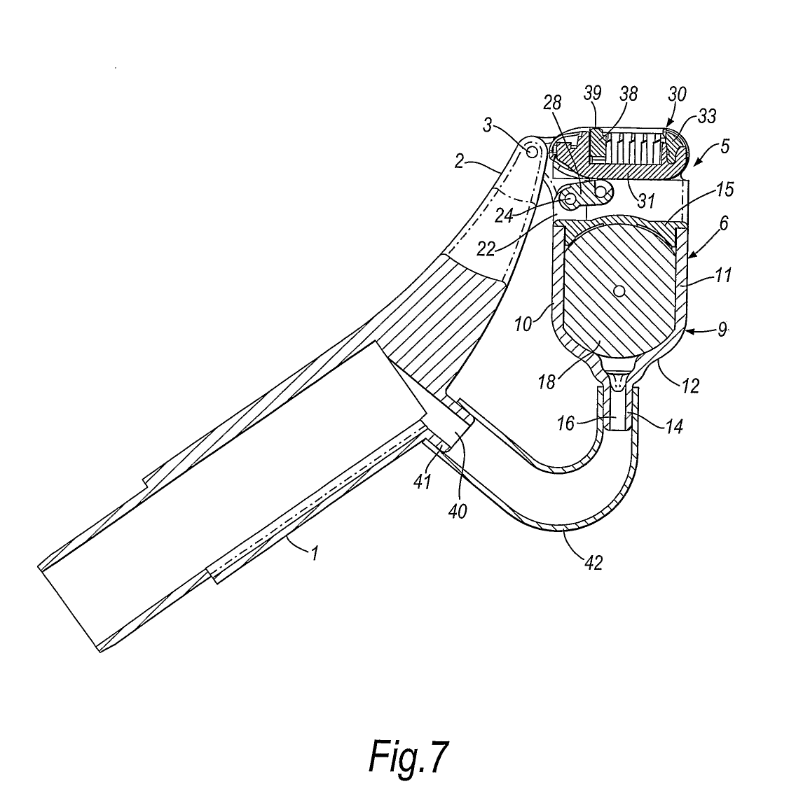

Illustrated in FIGS. 1-7 is an embodiment of a safety razor having a handle 1, only an upper part of which is shown. The handle has a bifurcated upper end defining a pair of yoke arms 2 having pivot elements 3 at their free ends. Pivotally connected to the pivot elements 3 for pivotal motion relative to the handle about a pivot axis A transverse to the length of the handle 1 is a razor head structure 5. The head structure includes a body 6 with a pair of end members 7 respectively connected to the pivot elements 3 and integrally attached to opposite end walls 8a, 8b of a motor housing 9. The end walls 8a, 8b are interconnected by front and rear housing walls 10, 11 and a bottom wall 12 formed with an externally projecting tubular spigot 14 defining a cable entry opening 16, and the top of the motor housing 9 is closed by a cover 15 sealed to the top edges of the front, rear and end walls. An electric motor 18 is sealed within the chamber enclosed by the housing 9 and has an output drive shaft 19 with an eccentric cam element 20 that protrudes through an end wall 8a of the motor housing and engages in a cam follower slot 21 provided in a crank arm 22. A flexible annular sealing member 26 seals between the end wall 8a of the motor housing and the crank arm 22 around the motor drive shaft 19 and cam element 20 for sealing the interior of the motor housing against ingress of moisture and other material. The crank arm 22 is rotationally fast with a rod 24 that is journalled for rotation in a pair of lugs 27 projecting upwardly on the end walls 8a, 8b of the motor housing. At a medial position along the rod 24 a lever arm 28 is fast with the rod so that the free end of this arm 28 oscillates up and down when the electric motor 18 is turned on. The free end of the lever arm 28 is positioned for engagement with a movable component of a shaving cartridge 30 replaceably mounted on the razor head structure 5. The shaving cartridge has a frame 31 carrying a plurality of blades 32 with sharp cutting edges, a guard with an elastomeric strip (not shown) having upstanding fins or other projections as well known per se, and a cap 33 including a strip of lubricating material. The outer ends of the frame are provided with grooves 35 for cooperation with complementary rails 36 provided on the inside faces of the end members 7 to allow the cartridge to be slid onto the head structure 5 from the rear thereof to take up the operative position illustrated in the drawings, and to be slid off of the head structure in the rearward direction when the cartridge is to be replaced. When correctly mounted in the operative position the cartridge 30 is fixed in position on the head structure for pivotal movement therewith relative to the handle 1 about the axis A. The cartridge includes a guard component 38 for contact with the skin during shaving in front of the blades 32 as they are moved across the surface of the skin being shaved. The guard component 38 consists of a elongate bar with upwardly directed projections 39 spaced apart along its length. The guard bar 38 is guided for vertical movement within the cartridge frame 31, the ends of the guard bar 38 being received in slots formed in the ends of the frame. The free end of the lever arm 28 is coupled to the underside of the guard bar 38 so that as the lever arm 28 is oscillated by the motor 18, the guard bar 38 is driven up and down relative to the other cartridge components, the projections 39 thereby being moved towards and away from the skin being shaved. A guard component reciprocated in this way may improve perceived comfort levels during shaving.

A rechargeable or replaceable battery for supplying electric current to power the motor 18 is accommodated in a lower part of the razor handle 1 not shown in the drawings. The electric cable conductors (also not shown) for carrying the electric current to the motor are routed upwardly through the handle to the upper part and out through an opening 40 formed through an external tubular spigot 41 on the handle. The spigot 41 is connected and sealed to the spigot 14 of the motor housing by flexible tube 42 through which the cable conductors pass to enter the motor housing 9 for connection to the motor 18 therein. In addition to forming a sealed cable duct the flexible tube 42 may act as a return spring to bias the razor head structure to a certain pivotal position on the razor handle.

It will be appreciated from the foregoing that by mounting the motor 18 within the pivotal head structure 5 a transmission system comprising simple and easily manufactured components to transfer motion from the motor 18 to the movable guard component 38 in a cartridge 30 that is able to pivot relative to the razor handle during shaving is achieved.

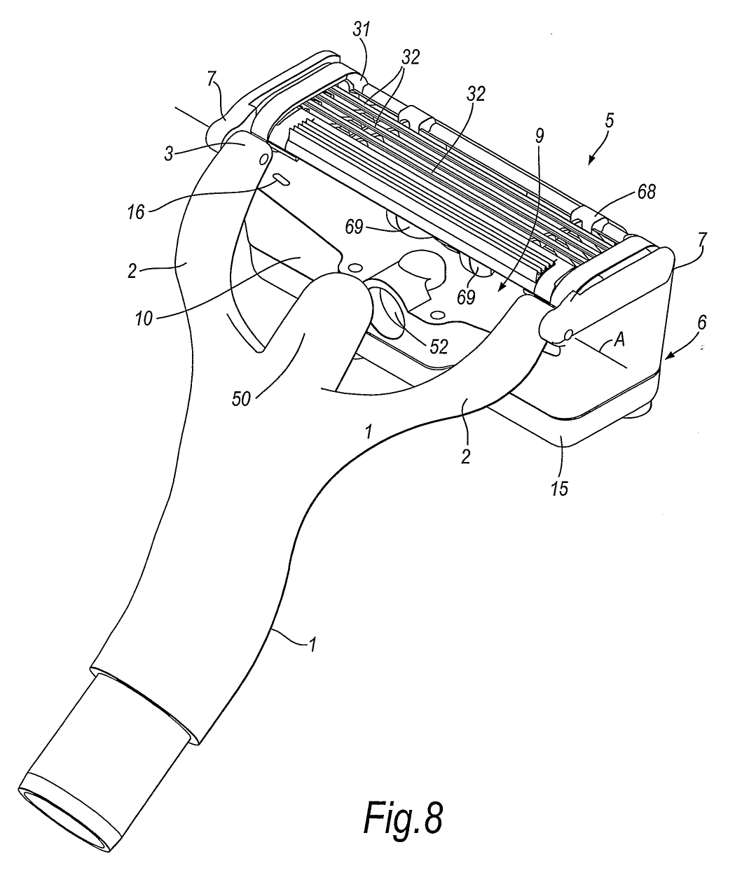

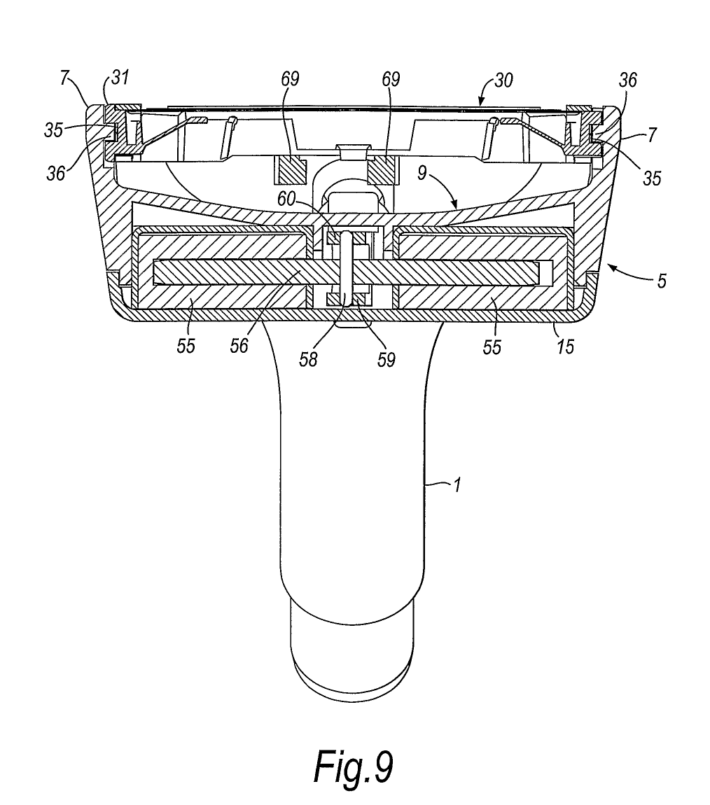

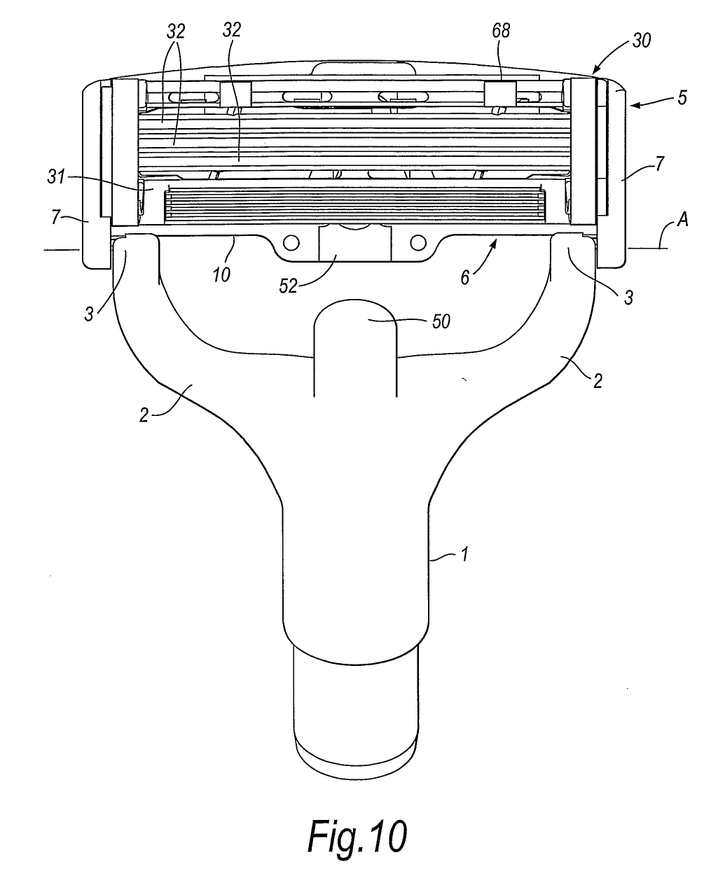

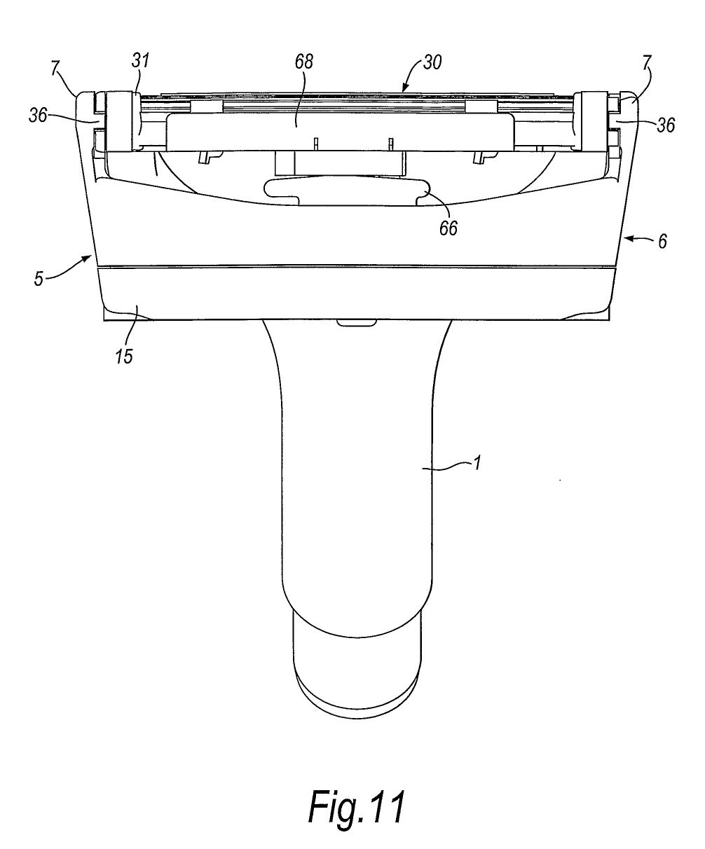

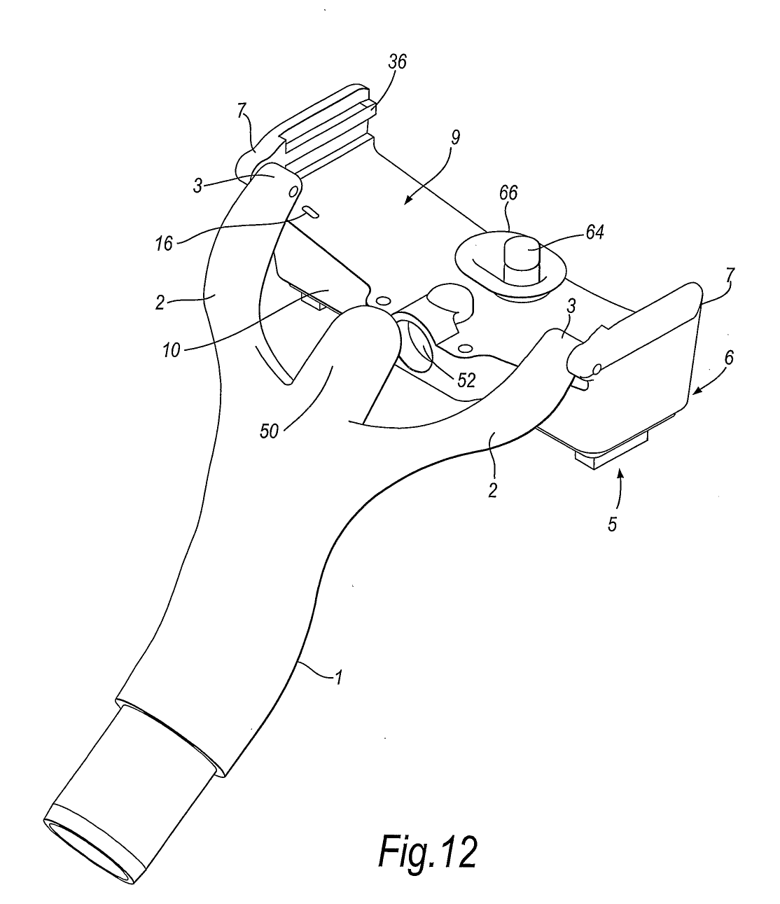

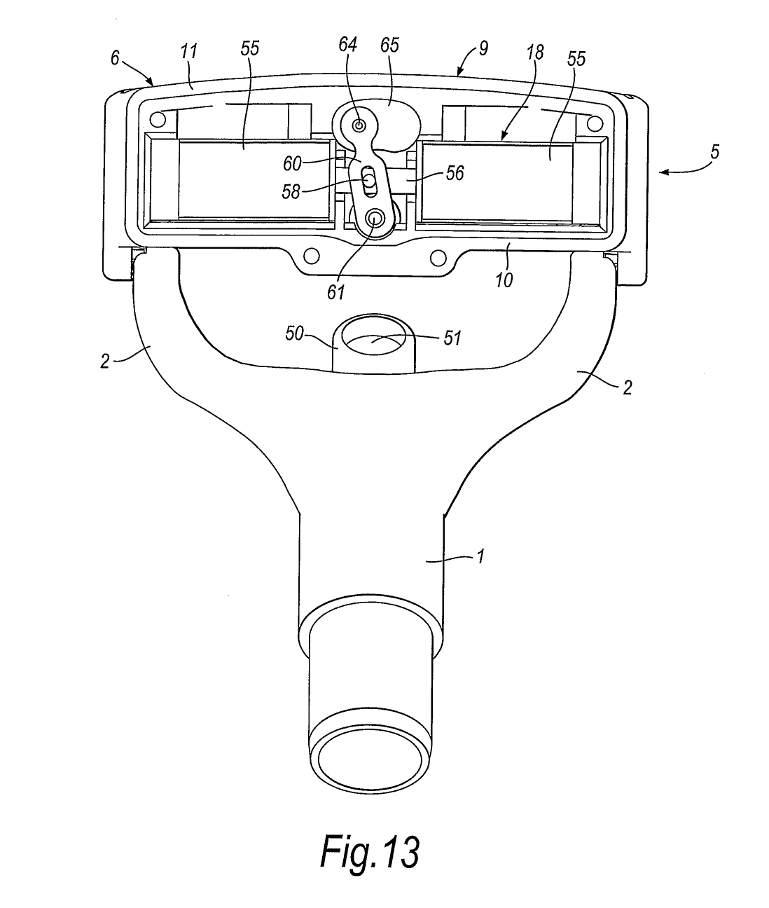

A second embodiment of a safety razor in accordance with the invention is illustrated in FIG. 8 to 13 and those parts of this embodiment, and the further embodiments described below, corresponding to those of the first embodiment described above are identified by the same reference numerals. The head structure 5 pivotally mounted to the razor handle 1 has a body 6 forming a motor housing 9 that is closed in a sealed manner by a bottom cover 15. The handle 1 includes an extension 50 formed with a socket 51 for accommodating a first magnet (not shown) and the motor housing 9 is provided with a similar socket 52 for accommodating a second magnet whereby the two magnets cooperate to control pivoting of the head structure 5 relative to the handle 1 in use of the razor. A cable entry opening 16 is formed in the top wall of the motor housing and in this embodiment a corresponding cable exit opening is provided at the end of the adjacent yoke arm 2 of the handle for directing electric cable conductors (not shown) to extend between the handle 1 and the head structure 5 for carrying electric current from the battery housed in the handle to the motor 18 housed within the chamber enclosed by the motor housing 9. The motor 18 in this embodiment is a dual solenoid linear motor, the solenoids 55 being disposed in an axially opposed arrangement for reciprocally driving an armature rod 56 that extends between them. A pin 58 extends perpendicularly through the middle of the drive rod 56, and the ends of the pin 58 extend through slots provided in respective lever arms 59, 60 that are conveniently provided by a unitary drive component. The lever arms 59, 60 have their first ends pivotally connected to the motor housing by a pivot pin 61 and at their second ends carry a drive pin 64. The drive pin projects upwardly through a hole 65 in the top wall of the motor housing and a flexible sealing boot 66 is connected between the drive pin 64 an the top wall to seal the motor chamber against ingress of water or the like. When the motor 18 is energised, the solenoids 55 are actuated with opposite reversing polarities so that the drive rod 56 is reciprocated back and forth moving the drive pin 58 with it between the solenoids, and thereby causing the drive component comprising the lever arms 59, 60 to oscillate about the axis of the pivot pin 61 and thereby the drive pin 64 to perform a reciprocal motion along an arcuate path centred on the axis of the pivot pin 61. The shaving cartridge 30 has a slide bar 68 guided for longitudinal sliding movement between the ends of the cartridge frame 31, and a pair of parallel fork arms 69 attached to the slide bar 68 extend forwardly beneath the cartridge so that the drive pin 64 is located between them. Consequently when the drive pin 64 is reciprocated along its arcuate path by energising the motor 18, the motion is transmitted to the fork arms 69 to cause the slide bar 68 to be reciprocated longitudinally of the cartridge 30. Since the slot between the fork arms 69 is open at their forward ends the sliding engagement and disengagement of the shaving cartridge with the razor head structure 5 is not impeded by the drive pin 64. The slide bar 68 can be coupled to any skin contacting component of the blade cartridge which is to be reciprocated for enhancing the shaving experience, such as a component at the guard of the cartridge, at the cap of the cartridge or one or more of the blades 32.

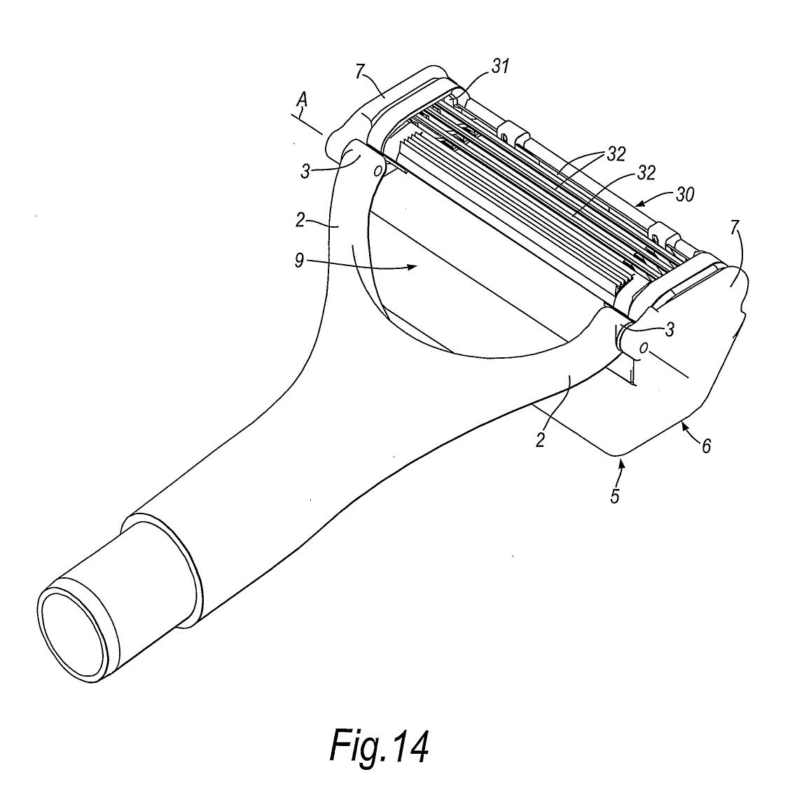

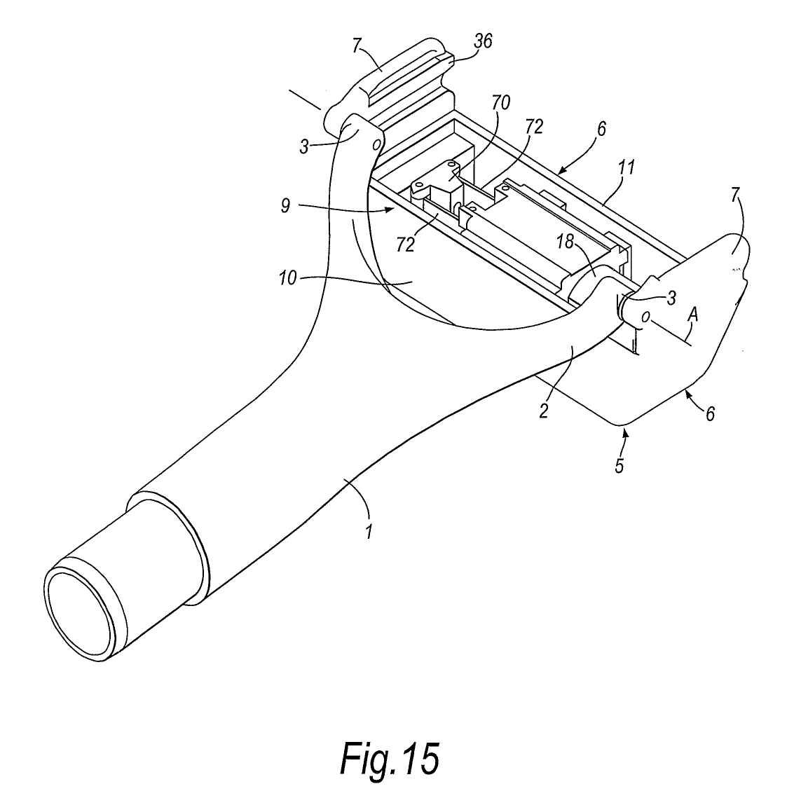

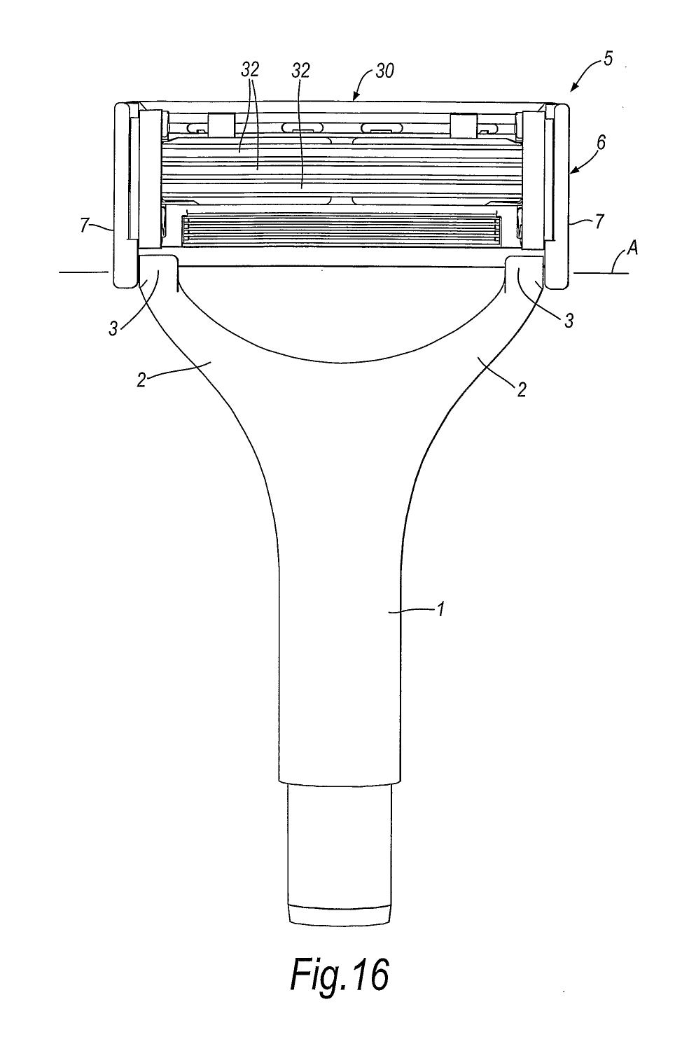

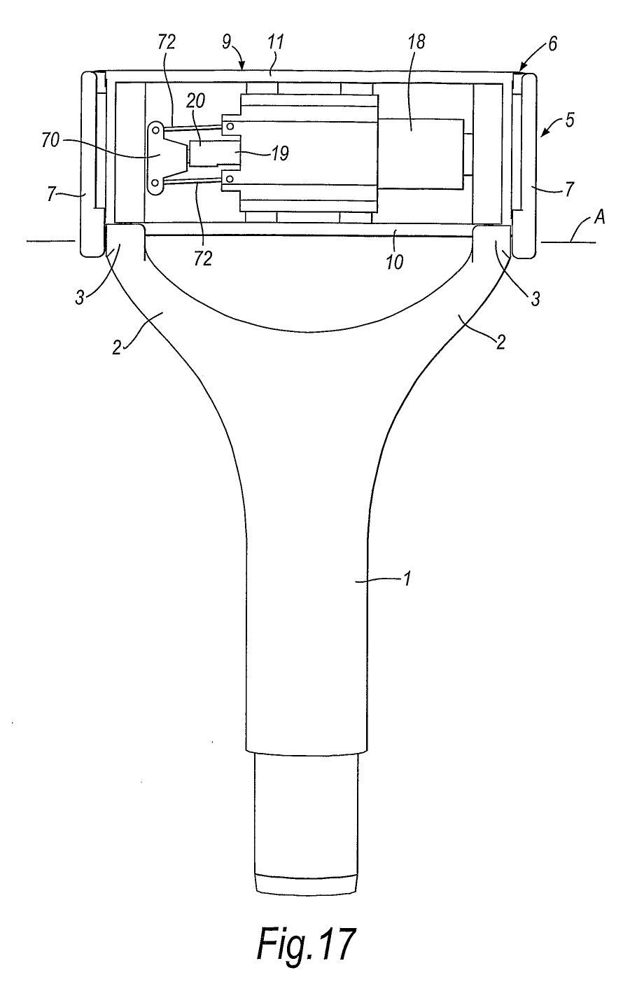

The third embodiment of a safety razor illustrated in FIGS. 14-17 is fundamentally the same as the previous two embodiments inasmuch that it has a head structure 5 pivotally mounted to a pair of yoke arms 2 extending from the upper end of the razor handle 1. In this embodiment a separate connection tube between the handle and the head structure for leading electric cable conductors from the handle to the head structure could be included but is not shown and in this embodiment the electrical conductors for delivering electric current from the battery accommodated in the handle to the motor 18 within the head structure are taken through at least one of the pivoted connections between the head structure 5 and the yoke arms 2. The head structure 5 includes a hollow body 6 defining a chamber that is closed by a top cover 15 to form a sealed motor housing 9. The electric motor 18 is fixedly mounted within the sealed chamber of the motor housing 9 and its rotary output shaft 19 carries an eccentric cam element 20 having a drive pin that is engaged in a slot provided in a weight 70 that is connected to the fixed motor support structure by a pair of parallel flexible links 72. When the motor 18 is energised the rotation of the output drive shaft 19 and cam element 20 cause the weight 70 to be vibrated back and forth in a direction parallel to the plane of the paper as seen in FIG. 17 and perpendicular to the pivot axis A. The vibration is transmitted to the pivotal head structure and hence to the shaving cartridge 30 that is securely mounted on the head structure 5 by means of the guide rails 36. It is well known that vibrating a shaving cartridge can produce a beneficial effect during shaving.

The direction in which the weight 70 is vibrated is is configurable depending on the vibration mode required. The vibration and the structure could easily be modified to vibrate the weight in other directions if desired, e.g. perpendicular to the cartridge face that contacts the skin. Also, an eccentric weight could be mounted directly to the output drive shaft 19 of the motor as known per se prior art razors having vibration mechanisms located entirely within the handle. With the entire mechanism, i.e. motor and weight, accommodated in the pivoted head structure 5 the moving parts are all remote from the handle 1 so that the vibration effect is concentrated at the region of the shaving cartridge and away from the handle where vibration is generally undesirable. Also, the vibration effect at the cartridge is constant in that there is no variation as the cartridge 30 and head structure 5 pivot relative to the handle 1.

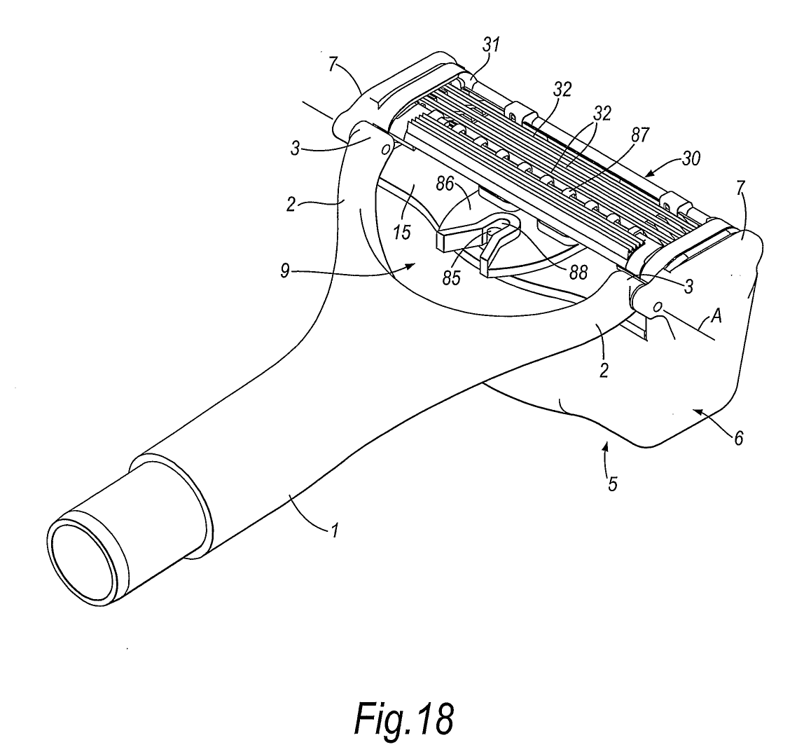

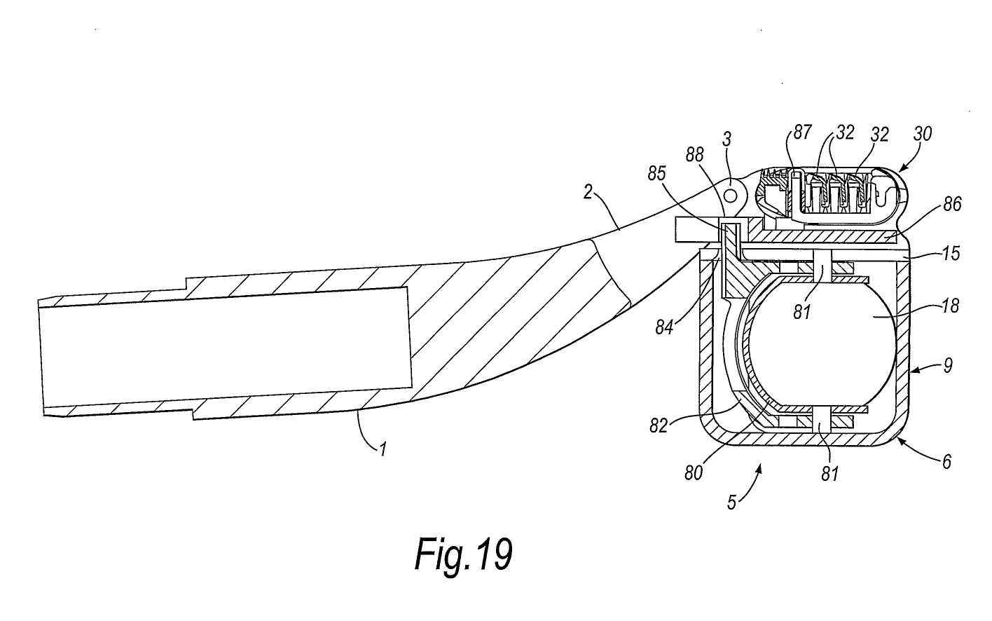

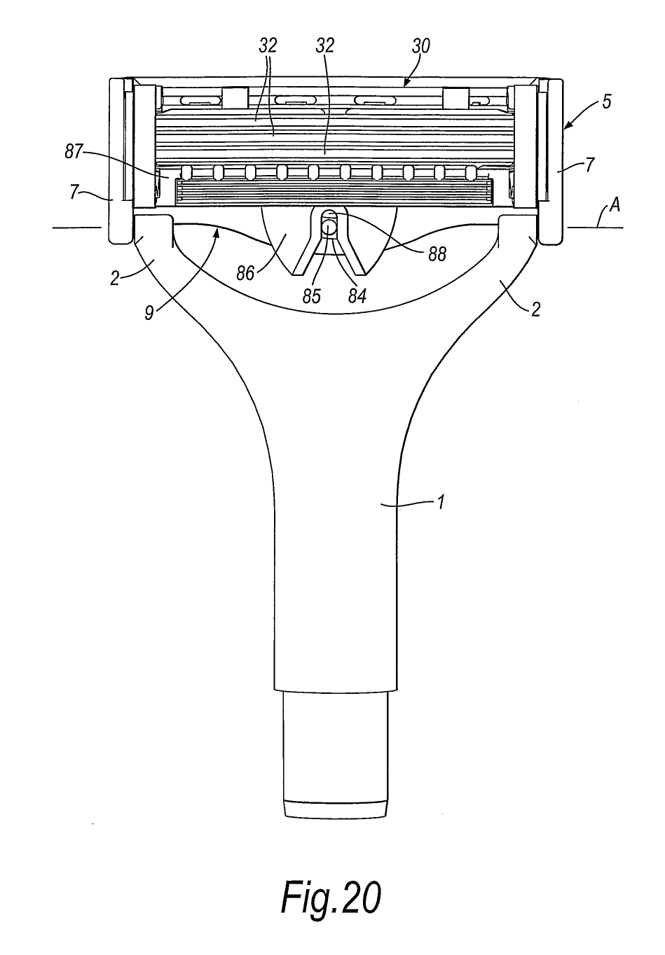

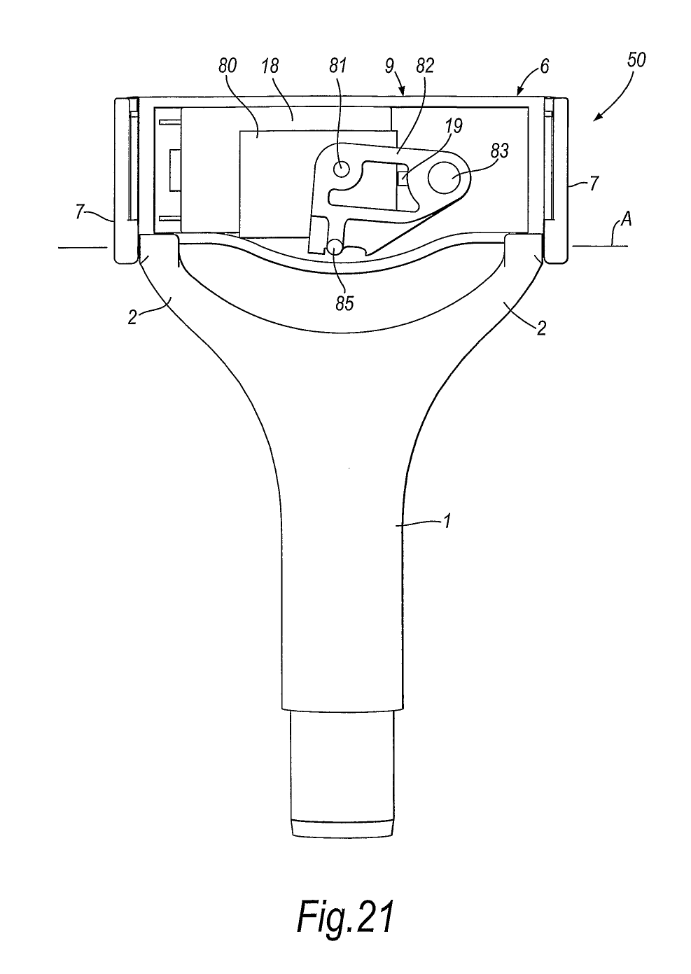

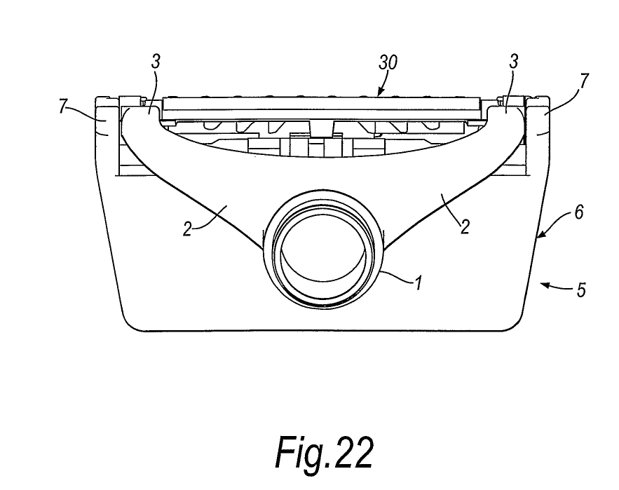

The fourth embodiment of a safety razor illustrated in FIGS. 18-22, like the previous embodiments, has a head structure 5 pivotally mounted to the upper end of a handle 1 by a pair of yoke arms 2 for pivoted movement about an axis A with respect to the handle. The head structure 6 includes a motor housing 9 sealed closed at the top by a cover 15. The motor 18 is firmly positioned within the chamber enclosed by the motor housing and a frame 80 carrying a pair of aligned pins 81 is fitted around the motor 18. A drive member 82 is journalled on the pins 81 and is coupled to the output drive shaft 19 of the motor 18 to be oscillated about the axis of the pins 81 when the motor is energised. The motor drive shaft 19 carries an eccentric cam element that is engaged in a hole in a pin 83. The drive member 82 includes a driving pin 85 that projects through an arcuate slot 84 in the cover 15 and is sealed to the cover by a flexible seal not shown, the pin 85 being reciprocated along an arcuate path when the motor 18 is energised. The electric current is delivered to the motor 18 from a battery housed in the razor handle 1 by cable conductors that can be led from the handle 1 to the head structure 5 by any one of the arrangements described above in connection with the previous embodiments. The driving pin 85 engages in a forwardly open slot 88 in a slide plate 86 coupled to a guard component 87 of the shaving cartridge 30 that is to be reciprocated in a direction parallel to the cutting edges of the blades 32. The cartridge is held in a fixed position on the body 6 of the head structure 5 and is slidably attachable to and detachable from the head structure as in the previous embodiments. To facilitate engagement of the pin 85 with the slot 88 when the cartridge is slid onto the guide rails 36 on the end members 7 of the body 6, the sides of the slot diverge in the forward direction to form a funnel to guide the pin 85 into the slot 88. It will be appreciated that the arcuate reciprocation of the pin 85 is transferred into a rectilinear reciprocation of the plate 86 and hence the guard component 87, and this reciprocation is readily achieved irrespective of the pivotal movement of the cartridge 30 relative to the razor handle 1 about the pivot axis A.

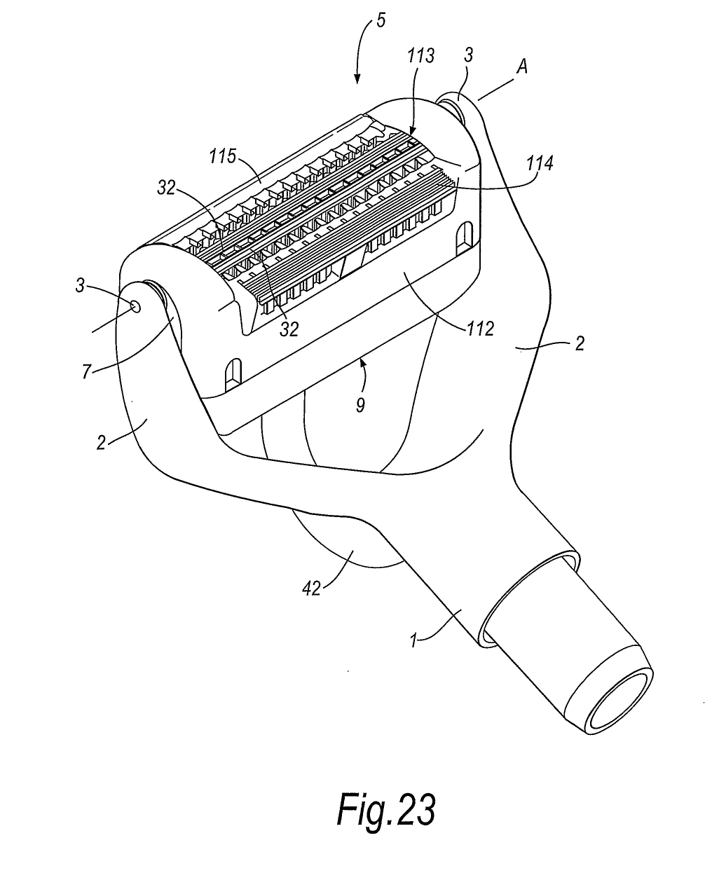

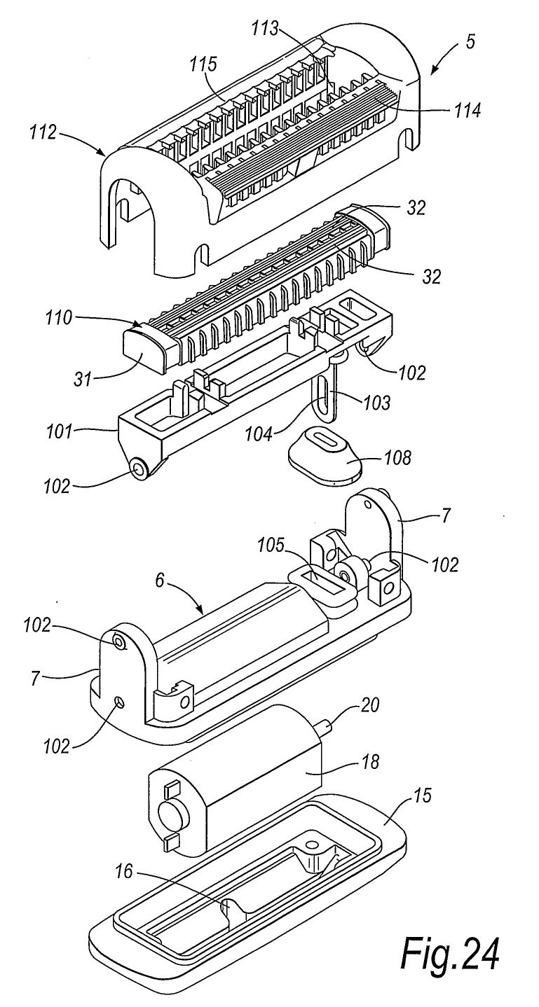

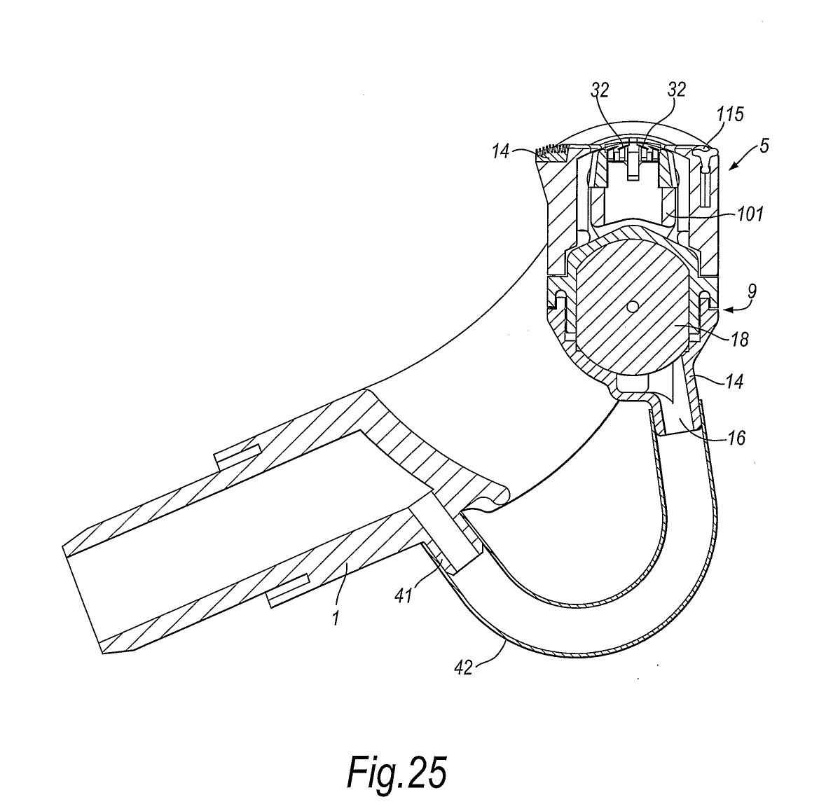

In FIGS. 23-26 a fifth embodiment of a safety razor according to the invention is illustrated. In common with the previous embodiments the razor comprises a head structure 5 pivotally connected to pivot elements 3 at the free ends of a pair of yoke arms 2 extending from the upper end of the razor handle, only an upper part of which is shown. The head structure 5 includes a body 6 with end members 7 carrying the pivot journals for cooperation with the pivot elements 3, and which together with a bottom cover 15 forms a motor housing 9 enclosing a sealed chamber in which an electric motor 18 is located. As in the first embodiment described above, a flexible tube 42 interconnects a spigot 41 on the handle with a spigot 14 on the motor housing for electrical cable conductors to pass between the handle 1 and the head structure 5 for conducting electric current from a battery accommodated in the handle to the electric motor 18.

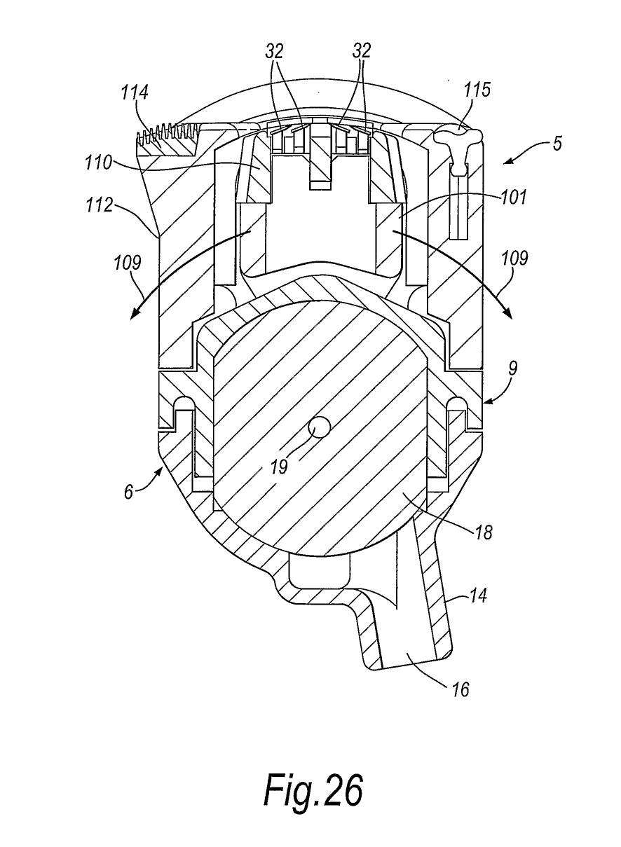

A blade unit platform 101 is pivotally mounted between the end members 7 by journals 102, and a drive arm 103 with an elongated slot 104 extends downwardly from the platform 101. The arm 104 passes freely through a slot 105 formed in the top wall of the motor housing to which the arm 104 is sealed by a flexible sealing boot 108. The output drive shaft 19 of the motor carries an eccentric cam element 20 which engages in the slot 104 so that, when the motor is energised, the blade unit platform 101 is caused to rock back and forth about its pivot as indicated by the arrows 109 in FIG. 26. The platform 101 carries a blade unit 110 that includes two sets of oppositely facing blades 32 supported on a frame 31 that is connected to the platform 101 so that the blade unit 110 rocks with the platform relative to the body 6 of the head structure 5. A cartridge casing 112 is fitted to the body 6 to enclose the blade unit 110 and the platform 101, the casing having an opening 113 through which the cutting edges of the blades 32 are exposed. As shown the cartridge casing 112 is provided with an elastomeric guard strip 114 at the front side of the opening 113 and a lubricating strip 115 defining a cap surface at the rear side of the opening 113. The head structure 5 as a whole is pivotable about the axis A relative to the handle 1. When the motor 18 is energised the platform 101 and blade unit 110 carried thereon are caused to oscillate so that the blades 32, and more importantly their cutting edges perform an arcuate reciprocation within the opening 113 of the cartridge casing 112 whereby the sets of blades 32 act alternately to cut hairs protruding from a skin surface against which the razor is applied in performing a shaving stroke. The arcuate reciprocation of the blade unit is achieved with a simple drive transmission between the motor 18 and the support platform 101 that is economic to manufacture and assemble, despite the fact that the shaving cartridge as a whole is free to pivot on the handle for following the skin contours in the course of executing a shaving stroke.

It should be understood that the foregoing description of the preferred embodiments is given by way of non-limiting example only and that modifications and variations are possible without departing from the scope of the invention as defined by the claims which follow. For example there are other ways in which electrical conductors can be connected between the handle 1 and the pivotable head structure, one possibility being to use a waterproofed flexible printed circuit board which, being flat can be easily clamped and sealed at the location where it enters the handle and motor housing. A flexible printed circuit board can be less bulky and have less influence on the rotation of the head structure than the flexible tube arrangements of the embodiments described above.

### LIST OF REFERENCE NUMERALS

A. Pivot axis
1. Razor handle
2. Yoke
3. Pivot elements
5. Head Structure
6. Body
7. End Members
8a & 8b End walls
9. Motor housing
10. Front wall
11. Rear wall
12. Bottom wall
14. Spigot
15. Cover
16. Cable entry
18. Motor
19. Drive Shaft
20. Cam element
21. Cam follower slot
22. Crank arm
26. Seal member
27. Lugs
28. Lever arm
30. Shaving cartridge
31. Cartridge frame
32. Blades
33. Cap
35. Grooves
36. Rails
38. Guard component
39. Projection
40. Cable opening
41. Spigot
42. Flexible tube
50. Handle extension
55. Solenoids
56. Armature rod
58. Pin
59. Lever arm
60. Lever arm
61. Pivot pin
64. Drive pin
65. Hole
66. Sealing boot
68. Slide bar
69. Fork arms
70. Weight
72. Flexible links
80. Frame
81. Pins
82. Drive member
83. Pin
84. Slot
85. Driving pin
86. Slide plate
87. Guard component
88. Slot
101. Platform
102. Journals
103. Drive arm
104. Slot
105. Slot
108. Sealing boot
109. Directional arrows
110. Blade unit
112. Casing
113. Opening
114. Guard strip
115. Lubricating strip

1. A safety razor comprising
a handle (1);
a head structure (5) pivotally connected to the handle, the head structure being pivotable relative to the handle in use of the razor;
a motor-driven device; and
a motor (18) for actuating the motor driven device,
characterised in that the motor (18) is located within the head structure (5).

2. A safety razor according to claim 1, wherein the handle (1) has an upper end, a lower end and a length extending between the upper and lower ends, the head structure (5) being pivotally connected to the upper end and being pivotable relative to the handle (1) about a pivot axis (A) transverse to the length of the handle.

3. A safety razor according to claim 1 or 2, wherein the head structure includes a body (6) with a sealed chamber formed therein, the motor (18) being housed in the sealed chamber.

4. A safety razor according to claim 3, wherein the motor (18) drives an output member extending through a wall (8a) of the sealed chamber for cooperation with an element (22) located outside the chamber, and a seal (26) is provided between either the output member or said element and said chamber wall.

5. A safety razor according to claim 4, wherein the seal comprises a flexible sealing member (26) extending between and said chamber wall (8a) and said output member or said element (22).

6. A safety razor according to any one of claims 1 to 5, wherein the motor (18) is a rotary motor.

7. A safety razor according to any one claims 1 to 5, wherein the motor (18) is a linear motor (55).

8. A safety razor according to any one of claims 1 to 7, wherein the motor has an axis, and the motor axis is substantially parallel to the axis (A) of pivotal movement of the shaving head (5) relative to the handle (1).

9. A safety razor according to any one of claims 1 to 7, wherein the motor (18) has an axis, and the motor axis is substantially perpendicular to the axis (A) of pivotal movement of the shaving head relative to the handle.

10. A safety razor according to any one of the preceding claims, wherein the head structure (5) includes a mounting structure (36) for detachably mounting a shaving cartridge (30) thereon.

11. A safety razor according to claim 10, wherein mounting structure is arranged to position the shaving cartridge (30) thereon for pivotal movement with the head structure relative to the handle.

12. A safety razor according to any one of claims 1 to 11, wherein the handle (1) includes a compartment for receiving a battery, and electrical conductors for conducting electric current between the battery and the motor extend between the handle and the head structure independently of the pivotal connection.

13. A safety razor according to claim 12, wherein a flexible tube (42) extends between the handle (1) and the head structure (5), and the electrical conductors pass through the flexible tube.

14. A safety razor according to any one of the preceding claims, wherein the motor (18) has a rotary output member (20) coupled to a mechanism to convert rotary motion of the output member into a reciprocal motion.

15. A safety razor according to any one of the preceding claims, wherein the motor driven device operates a movable skin contacting component (32; 38).

16. A safety razor according to claim 15, wherein the skin contacting component comprises a blade (32) having a cutting edge.

17. A safety razor according to claim 15, wherein the skin contacting component (38) has elements (39) for contacting the skin at discrete locations, the component being arranged to be reciprocated in a direction towards and away from the skin.

18. A safety razor according to claim 15, wherein the skin contacting component is a guard element (87) for contact with the skin in front of a blade edge in the performance of a shaving stroke.

19. A safety razor according to any one of claims 1 to 14, wherein the motor-driven device comprises a vibration mechanism (70, 72) for vibrating the head structure (5).

20. A safety razor according claim 19, wherein the motor (18) and the vibration mechanism (70, 72) are enclosed within a sealed motor housing (9).

21. A safety razor according to any one of the preceding claims, including a dispensing device to deliver a shaving enhancement fluid at the head structure, the dispensing device being operable by the motor.

22. A safety razor according to any one of the preceding claims, including a hair trimmer capable of being driven by the motor.

23. A safety razor according to any one of claims 1 to 13, wherein the motor-driven device is a blade unit support platform (101).

24. A safety razor according to claim 23, wherein the blade unit support platform (101) is mounted for pivotal movement within the head structure about an axis parallel to the axis (A) of pivotal movement of the head structure (5) relative to the handle (1).

25. A safety razor according to any one of claims 1 to 14, wherein the motor-driven device is operable to adjust relative positions of skin contacting components for changing the shaving geometry.

26. A safety razor according to any one of claims 1 to 14, wherein the motor-driven device actuates a skin contacting member operable to lift and/or extend hairs prior to being cut.

27. A safety razor cartridge comprising a frame (31) carrying at least one blade (32) having a sharp cutting edge, and a guard component (38) for contact with the skin in front of the at least one blade during shaving, the guard component having elements (39) for engagement with the skin at discrete locations, characterised in that the guard component (38) is guided in the frame (31) for reciprocation by a drive mechanism in a direction for movement of the elements towards and away from the skin.

28. A safety razor cartridge according to claim 27 wherein the elements comprises projections (39) spaced apart along an elongate bar.

29. A safety razor cartridge according to claim 28, wherein the ends of the elongate bar are guided in slots in the frame (31).
